(19) United States
(12) Patent Application Publication
(10) Pub. No.: US 2009/0015569 A1
(43) Pub. Date: Jan. 15, 2009

(54) IMAGE FORMING APPARATUS, INFORMATION PROCESSING APPARATUS AND DISPLAY CONTROL METHOD

(75) Inventors: Masahiro Machida, Ebina-shi (JP); Hidekazu Ozawa, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 11/945,291

(22) Filed: Nov. 27, 2007

(30) Foreign Application Priority Data
Jul. 10, 2007 (JP) 2007-180668

(51) Int. Cl. G09G 5/00

(52) U.S. Cl. 345/204

(57) ABSTRACT

An image forming apparatus includes a display that displays a normal operational screen and information other than the normal operational screen; a display controller that operates to switch what is displayed between a normal operational screen and information other than the normal operational screen and display the data on the display; and a driving unit that drives the display to change a placement state of the display between one state where a normal operational screen is displayed on the display and another state where information other than the normal operational screen is displayed on the display.

### CROSS-REFERENCE TO RELATED APPLICATIONS

This application is based on and claims priority under 35 USC 119 from Japanese Patent Application No. 2007-180668 filed Jul. 10, 2007.

### BACKGROUND

1. Technical Field

The present invention relates to an image forming apparatus, an information processing apparatus and display control method for displaying information other than a normal operational screen, such as advertising information.

2. Related Art

Recently, image forming apparatus such as copiers and printers is installed not only at offices, but also in public places where general public often come in, such as convenience stores, libraries, and city halls. A display attached to the image forming apparatus to display an operational screen becomes larger. Consequently, some image forming apparatus becomes capable of displaying information other than a normal operational screen such as advertising information on its display to make effective use of the display.

When information other than a normal operational screen such as advertising information is displayed on the display, it is more effective to place the display in a position where what is displayed is easy for surrounding general public to see. However, if the display is placed in such a position, what is done by an operation on the screen that the operator wants to hide from the eyes of a stranger around him or her, such as an operation for authentication by entering a password, entering a destination address of facsimile transmission, etc. may catch the eye of someone who happens to be around. This situation is not very good in terms of both protection of personal information and security.

However, if the display is placed in a position where what is displayed is hard for people around it to see, it becomes difficult to obtain the effect of making effective use of the display by displaying information other than a normal operational screen, such as advertising information, on the display.

### SUMMARY

An image forming apparatus according to an aspect of the invention includes a display that displays a normal operational screen and information other than the normal operational screen; a display controller that operates to switch what is displayed between a normal operational screen and information other than the normal operational screen and display the data on the display; and a driving unit that drives the display to change a placement state of the display between one state where a normal operational screen is displayed on the display and another state where information other than the normal operational screen is displayed on the display.

### BRIEF DESCRIPTION OF THE DRAWINGS

Exemplary embodiments of the present invention will be described in detail based on the following figures, wherein:

FIG. 1 is a system schematic diagram showing a framework of an image processing system for a first exemplary embodiment of the invention;

FIG. 2 is an enlarged outside view of an image forming apparatus 10 of the first exemplary embodiment of the invention;

FIG. 3 is a block diagram depicting a hardware structure of the image forming apparatus 10 of the first exemplary embodiment of the invention;

FIG. 4 is a block diagram depicting an arrangement of functions of the image forming apparatus 10 of the first exemplary embodiment of the invention;

FIGS. 5A and 5B are illustrations to explain an example of display switch control by a display controller 52;

FIG. 6 illustrates an example of a placement state of the display when advertising information is displayed on a display 11 in the image forming apparatus 10 of the first exemplary embodiment of the invention;

FIG. 7 illustrates an example of a placement state of the display when a normal operational screen is displayed on the display 11 in the image forming apparatus 10 of the first exemplary embodiment of the invention;

FIG. 8 is a flowchart for explaining display switch control and placement position control of the display 11 in the image forming apparatus 10 of the first exemplary embodiment of the invention;

FIG. 9 illustrates an example of a placement state of the display when a normal operational screen is displayed on the display 11 in the image forming apparatus of a second exemplary embodiment of the invention; and

FIG. 10 illustrates an example of a placement state of the display when advertising information is displayed on the display 11 in the image forming apparatus of a second exemplary embodiment of the invention.

### DETAILED DESCRIPTION

Then, exemplary embodiments of the invention are described in detail with reference to the drawings.

### First Exemplary Embodiment

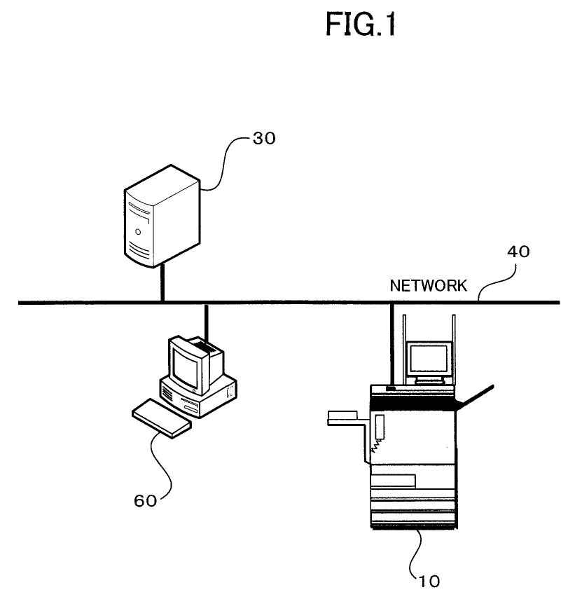

FIG. 1 is a diagram showing a framework of an image processing system including an image forming apparatus of a first exemplary embodiment of the invention.

As shown in FIG. 1, the image processing system for the present exemplary embodiment includes an image forming apparatus 10, a terminal device 60, and an advertising information distribution server 30 interconnected via a network 40.

The advertising information distribution server 30 stores a variety of advertising information to be presented on a display of the image forming apparatus 10 and distributes advertising information to the image forming apparatus 10 according to a prearranged procedure. The terminal device 60 generates printing data such as print jobs and transmits such data to the image forming apparatus 10. The image forming apparatus 10 is a complex machine having a printing function, a copying function, a facsimile transmitting/receiving function, and a scanning function. The image forming apparatus 10 receives printing data transmitted from the terminal device 60 and outputs an image corresponding to the printing data on printing paper. Moreover, it displays advertising information distributed from the advertising information distribution server 30 on the display.

In the present exemplary embodiment, the invention is explained for a situation where advertising information is taken as information other than a normal operational screen. Alternatively, the invention can be applied in the same way for other situations where information other than advertising information, such as information about train situation, nearby sightseeing information, and event information is displayed as information other than the operational screen on the display of the image forming apparatus 10.

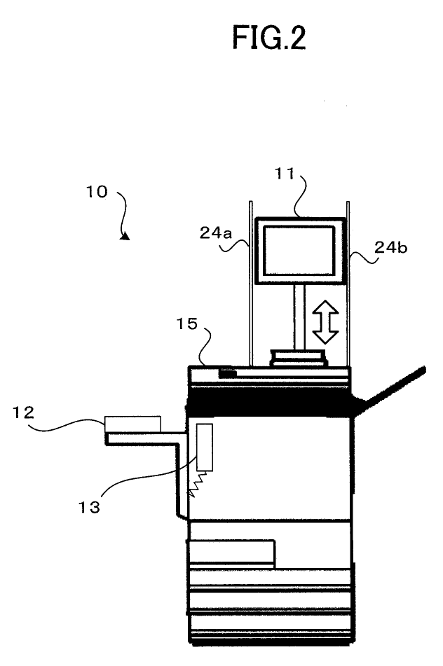

Next, an enlarged outside view of the image forming apparatus 10 of the present exemplary embodiment is shown in FIG. 2. The image forming apparatus 10 of the present exemplary embodiment as shown in FIG. 2 includes a display 11 for displaying a normal operational screen and advertising information, an authentication device 12, a telephone set 13, and an image reader 15.

The display 11 is supported between guides 24a, 24b on its left and right sides and movable up and down along the guides 24a, 24b by a driving device which is not shown.

The authentication device 12 authenticates a user who has an authentication card by reading identification information from the authentication card on which such information has already been stored, such as, for example, a contactless IC card. The telephone set 13 is linked to a public telephone line and can be used as an ordinary telephone. When the facsimile function of the image forming apparatus 10 is used, the user may first make a call to a destination over the telephone line, using the telephone set 13, and, after making sure of the connection to the destination, send facsimile data.

The image reader 15 is a device for reading an image of an original to be copied, a page to be scanned by a scanner, or a page to fax.

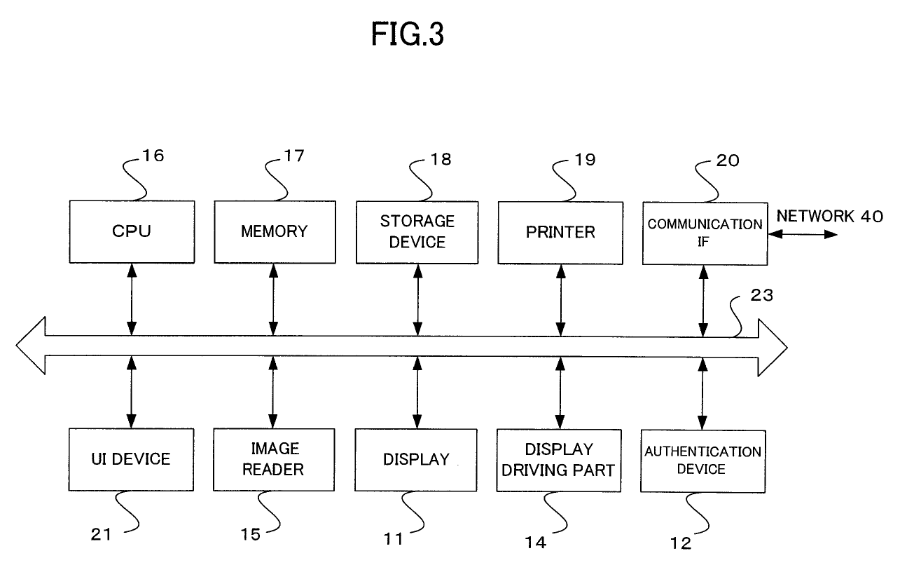

Next, a hardware structure of the image forming apparatus 10 of the present exemplary embodiment is shown in FIG. 3.

The image forming apparatus 10, as shown in FIG. 3, includes a CPU 16, a memory 17, a storage device 18 such as a hard disk drive (HDD), a printer 19, a communication interface (IF) 20 which transmits and receives data to/from a remote machine such as the advertising information distribution server 30, terminal device 60, and the like via the network 40, a user interface (UI) device 21 including a touch panel, manual operation buttons or indicator lamps, and the like, an image reader 15, a display 11, a display driving part 14, and an authentication device 12. These components are interconnected via a control bus 23.

The CPU 16 executes predetermined processing based on an image processing program stored in the memory 17 or the storage device 18 and controls the operation of the image forming apparatus 10.

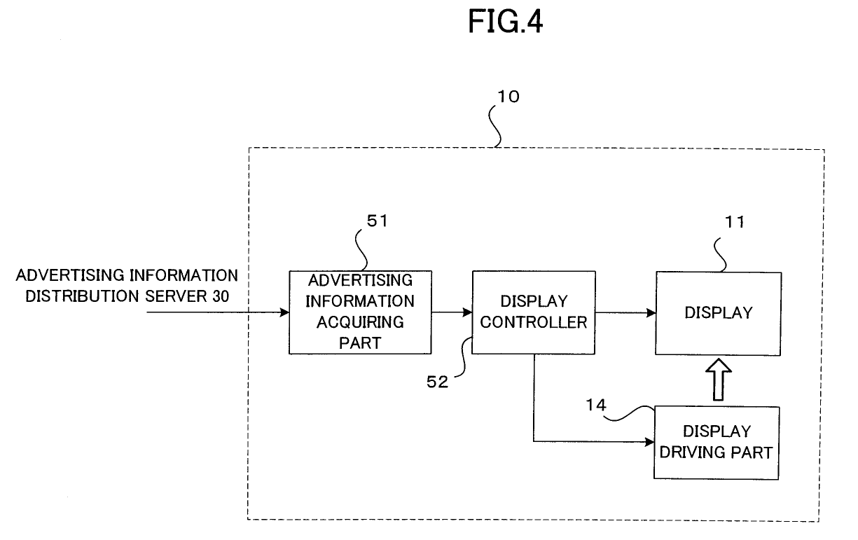

FIG. 4 is a block diagram depicting an arrangement of functions of the image forming apparatus 10, which are realized by executing the image processing program.

The image forming apparatus 10 of the present exemplary embodiment as shown in FIG. 4 is provided with an advertising information acquiring part 51, a display controller 52, the display 11, and the display driving part 14.

The advertising information acquiring part 51 acquires advertising information distributed from the advertising information distribution server 30 via the network 40.

The display controller 52 generates image data for advertising information to display, acquired by the advertising information acquiring part 51, by use of application software such as a WWW (World Wide Web) browser. Also, the display controller 52 generates image data for a normal operational screen to display for operating the image forming apparatus 10 by use of application software such as the WWW browser.

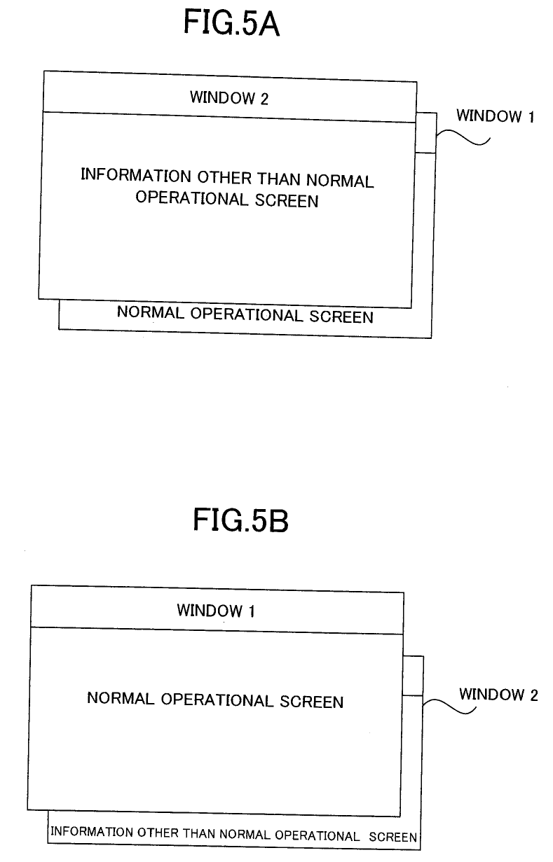

The display controller 52 operates to switch what is displayed on the display 11 between a normal operational screen and advertising information and display the data on the display 11. Referring to FIGS. 5A and 5B, display switch control by the controller 52 is explained.

As shown in FIGS. 5A and 5B, Window 1 to display a normal operational screen and Window 2 to display information other than the normal operational screen such as advertising information are prepared in advance. By changing the window displayed to the fore, the display controller 52 switches what is displayed on the display 11.

For example, in FIG. 5A, the display controller 52 displays Window 2 where information other than the normal operational screen is displayed to the fore over Window 1. Thereby, information other than the normal operational screen is displayed on the display 11. In this state, when Window 1 is displayed to the fore, as shown in FIG. 5B, the normal operation screen is displayed on the display 11.

The display driving part 14 drives the display 11 to change the placement state of the display between one state where a normal operational screen is displayed on the display 11 and another state where advertising information is displayed on the display 11. A concrete mechanism of the display driving part 14 can be realized by a generally known structure including gears, position detecting switches, a motor, a motor controller, etc. Therefore, detailed explanation thereof is omitted herein.

Specifically, the display driving part 14 drives the display 11 to set it in one placement state allowing only the operator to see what is displayed when a normal operational screen is displayed on the display 11, and drives the display 11 to set it in another placement state allowing both the operator and other persons around to see what is displayed when advertising information is displayed on the display 11.

In the present exemplary embodiment, the display driving part 14 drives the display 11 to change its placement state by moving the placement position of the display 11 up and down along the guides 24a, 24b.

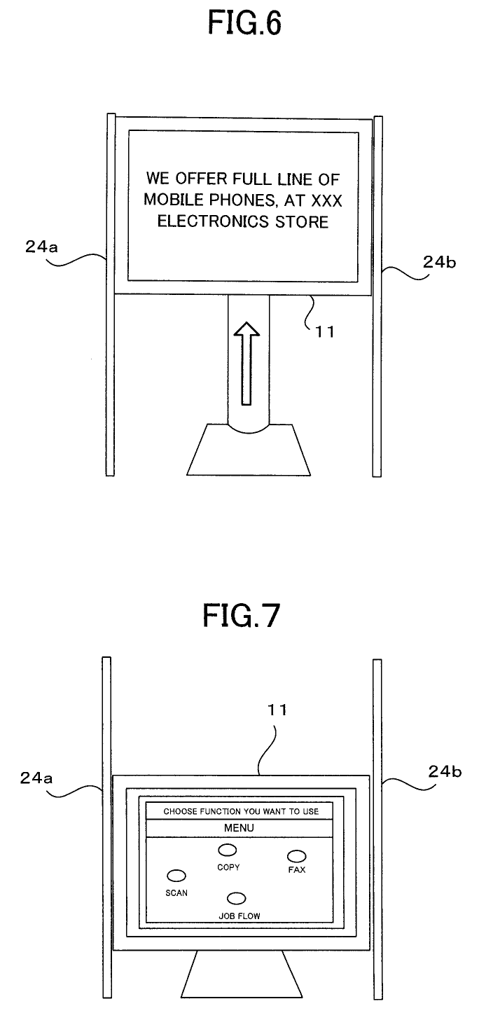

Movement of the placement position of the display 11 moved by the display driving part 14 is exemplified in FIGS. 6 and 7.

FIG. 6 illustrates an example where advertising information “We offer full line of mobile phones, at XXX Electronics Store” is displayed on the display. FIG. 7 illustrates an example where a normal operational screen, a menu screen for selecting a function of the image forming apparatus 10 is displayed on the display 11.

When advertising information is displayed on the display 11, the display driving part 14 controls the display 11 to move it up vertically along the guides 24a, 24b, as shown in FIG. 6. Thereby, the placement position of the display becomes higher than its normal placement position, so that what is displayed is easy for both the operator and other persons around to see.

When a normal operational screen is displayed on the display 11, the display driving part 14 controls the display 11 to move it down vertically along the guides 24a, 24b as shown in FIG. 7. Thereby, the placement position of the display 11 becomes lower than the placement position at which advertising information is displayed. In this state, for the operator, what is displayed is easy to see and operation is easy to perform, whereas, for persons around other than the operator, what is displayed is hard to see.

Next, the operation of the image forming apparatus 10 of the present exemplary embodiment is described in detail with reference to the relevant drawing.

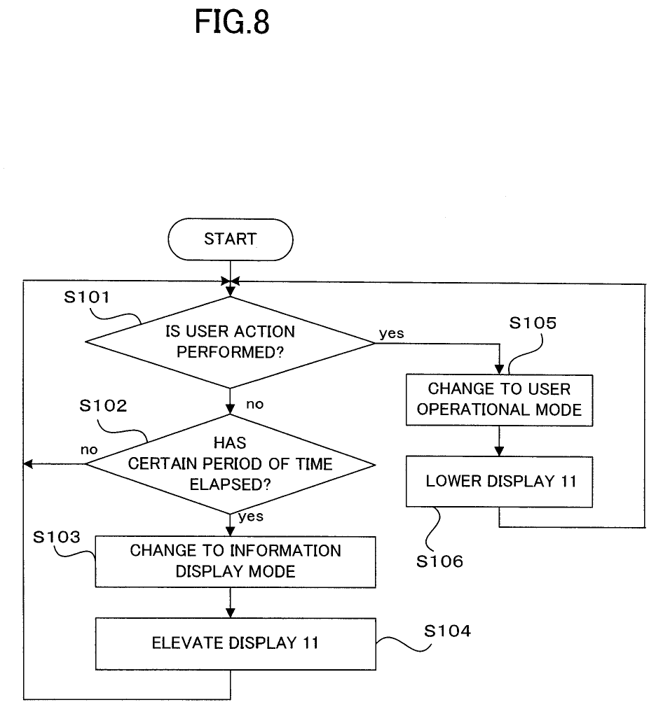

Referring to a flowchart of FIG. 8, display switch control and placement position control of the display 11 in the image forming apparatus 10 of the present exemplary embodiment will be explained.

In the following, information display mode is a mode in which information other than the normal operational screen such as advertising information is displayed on the display 11. User operational mode is a mode in which a normal operational screen for using various functions of the image forming apparatus 10 is displayed on the display 11.

The explanation assumes that, initially, the operating mode of the image forming apparatus 10 is user operational mode in which a normal operational screen is displayed on the display 11. In the user operational mode, if no user action has occurred for a certain period of time (step S101, S102), the operating mode is changed to information display mode (step S103). On the display 11, information other than the normal operational screen such as advertising information is displayed. At the same time, the display driving part 14 changes the display placement position by elevating the display 11 along the guides 24a, 24b as shown in FIG. 6 (step S104).

In the information display mode of the image forming apparatus 10, when any user action is performed (step S101), the operating mode is changed to the user operational mode (step S105). On the display 11, a normal operational screen such a menu screen is displayed. At the same time, the display driving part 14 changes the display placement position to the initial lower position by lowering the display 11 along the guides 24a, 24b as shown in FIG. 7 (step S106).

### Second Exemplary Embodiment

Next, an image forming apparatus of a second exemplary embodiment of the invention is described.

In the image forming apparatus of the above-described first exemplary embodiment, the display placement state is changed by moving the display 11. On the other hand, in the image forming apparatus of the present exemplary embodiment, the display driving part drives the display 11 to set the display in another placement state by changing the placement angle of the display 11.

The display 11 in the present exemplary embodiment is provided with a mechanism that rotates the display panel on its bottom edge. By being driven by the display driving part, the placement state of the display screen is switched between one state where the screen is laid on the level and another state where the screen stands upright, facing the operator.

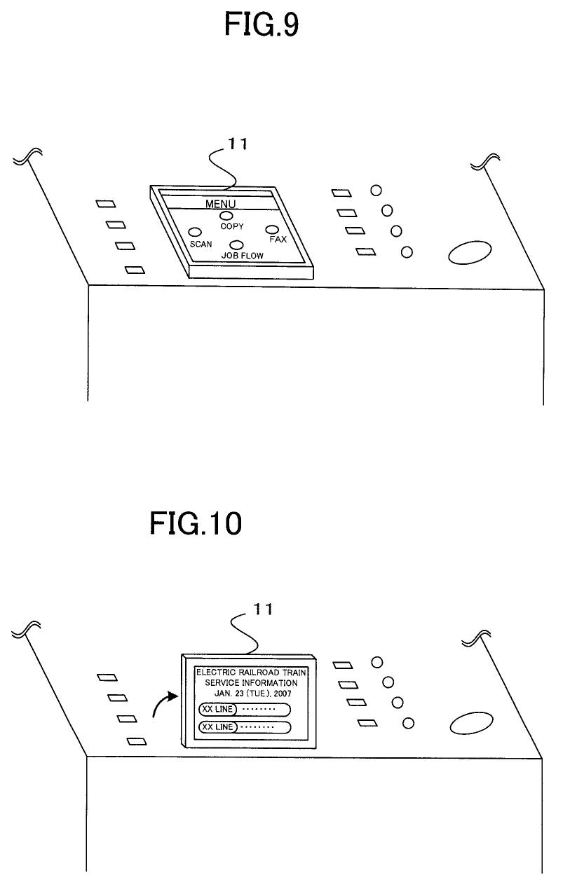

In the image forming apparatus of the present exemplary embodiment, when a normal operational screen is displayed on the display 11, the display 11 is driven and set in one placement state where the screen is laid on the level as shown in FIG. 9. In this state, what is displayed is easy for the operator to see, but hard for persons around other than the operator to see.

In the image forming apparatus of the present exemplary embodiment, when information other than the normal operational screen such as advertising information is displayed on the display 11, the display 11 is driven and set in another placement state where the screen stands upright, facing the operator, as shown in FIG. 10, as the result of changing the placement angle. In this state, what is displayed is easy for both the operator and other persons around to see.

### [Modifications]

In the foregoing exemplary embodiments, the invention is explained for a situation where information other than the normal operational screen such as advertising information is displayed on the display 11 of the image forming apparatus 10; however, the invention is not so limited. In an information processing apparatus with a display, such as an ATM (Automated Teller Machine) terminal device, a POS (Point-Of-Sales) terminal device, or the like, the present invention can be applied in the same way even for a situation where information different from information that is normally displayed, such as advertising information or a variety of guidance information is displayed on the display.

The display placement state is changed by changing the placement angle of the display 11 in the foregoing first exemplary embodiment, whereas the display placement state is changed by moving the placement position of the display 11 in the foregoing second exemplary embodiment. Alternatively, the display placement state may be changed by changing both the placement angle and the placement position.

Further, in the forgoing exemplary embodiments, the display driving part 14 changes the placement state of the display 11 according to what is displayed on the display 11. Alternatively, the placement state of the display 11 may be changed according to other information than what is displayed. For example, in a case where, after the operator is authenticated by the authentication device 12 as shown in FIG. 2, the operator is allowed to use the image forming apparatus 10, the placement state of the display 11 may be changed according to properties of the operator such as age, sexuality, and with/without disabilities. In particular, the display drive may be controlled such that: if the operator is a person with any disability and uses a wheelchair, the placement position of the display 11 is set much lower than the normal position; or if the operator is a child, the display position is slightly lower than the normal position.

Moreover, the image forming apparatus 10 may be provided with an external access function. In a case where external access using this function is performed and a site at which personal information should be entered is displayed on the display 11, it is also possible to change the placement state of the display 11 to a state where the display is hard for persons around to see. In such a case, a URL of an access destination, where a user should input personal information or the like, is registered in advance. When a URL of an access destination specified by use of the external matches with the registered URL, the placement state of the display 11 may be changed to a state where the display is hard for persons around to see.

Instead of setting the display 11 in a placement state where the display is easy for only the operator to see whenever what is displayed on the display 11 is a normal operational screen, the placement state of the display 11 may be changed to this state only when the user is going to enter personal information such as a password and a fax destination.

The present invention may be embodied in other specific forms without departing from its spirit or characteristics. The described exemplary embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. An image forming apparatus comprising:
a display that displays a normal operational screen and information other than the normal operational screen;
a display controller that operates to switch what is displayed between a normal operational screen and information other than the normal operational screen and display the data on the display; and
a driving unit that drives the display to change a placement state of the display between one state where a normal operational screen is displayed on the display and another state where information other than the normal operational screen is displayed on the display.

2. The image forming apparatus according to claim 1, wherein the driving unit drives the display to set the display in another placement state by changing a placement angle of the display.

3. The image forming apparatus according to claim 1, wherein the driving unit drives the display to set the display in another placement state by moving a placement position of the display.

4. The image forming apparatus according to claim 1, wherein the driving unit drives the display to set the display in one placement state allowing only an operator of the apparatus to see what is displayed when a normal operational screen is displayed on the display, and drives the display to set the display in another placement state allowing both the operator and other persons around to see what is displayed when information other than the normal operational screen is displayed on the display.

5. The image forming apparatus according to claim 4, wherein the driving unit drives the display to set the display in another placement state by changing a placement angle of the display.

6. The image forming apparatus according to claim 4, wherein the driving unit drives the display to set the display in another placement state by moving a placement position of the display.

7. An image processing apparatus comprising:
a display that displays a normal operational screen and information other than the normal operational screen;
a display controller that operates to switch what is displayed between a normal operational screen and information other than the normal operational screen and display the data on the display; and
a driving unit that drives the display to change a placement state of the display between one state where a normal operational screen is displayed on the display and another state where information other than the normal operational screen is displayed on the display.

8. The information processing apparatus according to claim 7, wherein the driving unit drives the display to set the display in one placement state allowing only an operator of the apparatus to see what is displayed when a normal operational screen is displayed on the display, and drives the display to set the display in another placement state allowing both the operator and other persons around to see what is displayed when information other than the normal operational screen is displayed on the display.

9. The information processing apparatus according to claim 7, wherein the driving unit drives the display to set the display in another placement state by changing a placement angle of the display.

10. The information processing apparatus according to claim 7, wherein the driving unit drives the display to set the display in another placement state by moving a placement position of the display.

11. A display control method comprising:
driving a display to set the display in one placement state allowing only an operator of the apparatus to see what is displayed when a normal operational screen is displayed on the display; and
driving the display to set the display in another placement state allowing both the operator and other persons around to see what is displayed when information other than the normal operational screen is displayed on the display.
